(19) United States
(12) Patent Application Publication
(10) Pub. No.: US 2009/0095041 A1
(43) Pub. Date: Apr. 16, 2009

(54) METHOD AND APPARATUS USING FOAMED GLASS FILTERS FOR LIQUID PURIFICATION, FILTRATION, AND FILTRATE REMOVAL AND ELIMINATION

(76) Inventors: W. Gene Ramsey, Las Cruces, NM (US); Andrew Ungerleider, Santa Fe, NM (US)

Correspondence Address: TAFT STETTINIUS & HOLLISTER LLP, ONE INDIANA SQUARE, SUITE 3500, INDIANAPOLIS, IN, 46204, US

(21) Appl. No.: 11/872,935

(22) Filed: Oct. 16, 2007

(51) Int. Cl. A62D 3/00; G21F 9/16; A62D 3/02; A62D 3/30; C01B 21/48; C05C 1/00; B01D 37/00

(52) U.S. Cl. 71/58; 210/769; 210/767; 210/791; 210/749; 210/768; 423/397; 210/615; 588/11; 588/256

(57) ABSTRACT

A method of disposing of waste material in a waste stream, including positioning a porous foamed glass member characterized by an open-cell interconnected pore network in contact with a volume of liquid to be purified and removing an amount of an undesired material from the volume of liquid.

### TECHNICAL FIELD

The novel technology relates generally to the materials science, and, more particularly, to a method for using porous foamed glass bodies for the filtration of fluids.

### BACKGROUND

As more and more land is being used for either residential or agricultural purposes, available water for drinking, washing and irrigation is becoming scarcer. Water reclamation, recycling and purification is, accordingly, of increasing importance. One method of removing unwanted particulate material from water or other liquids is via filtration. The most common type of commercial or large-scale water filter is a rapid sand filter. Water passes vertically through sand, which is often arranged having a layer of activated carbon or anthracite coal thereabove top remove organic compounds. The space between sand particles is typically larger than the smallest suspended particles, so simple filtration is typically insufficient. This is addressed by extending the volume of the filter through which the water must pass, so that particles tend to be trapped in pore spaces or adhere to sand particles. Thus, effective filtration is a function of the depth of the filter, and in fact if the top portions were to block all of the filtrate particles, the filter would quickly clog.

One drawback of sand filters is their great volume. This is addressed by the use of pressure filters. Pressure filters work on the same principle as gravity filters, but for the enclosure of the filter medium is in a (typically steel) vessel through which water is forced under pressure. Pressure filters may filter out much smaller particles than sand filters can, but require bulky and expensive pressure pumps and containment vessels, and are thus unattractive for smaller scale filtration applications.

Another filtration option is the use of membrane filters. Membrane filters are widely used for filtration of both drinking water and sewage. Membrane filters typically employ thin, porous polymer or ceramic members to filters out virtually all particles larger than their specified pore sizes, typically down to about 0.2 microns. The membranes are quite thin and liquids may thus flow through them fairly rapidly. Membranes may be made strong enough to withstand slightly elevated pressure differentials and may also be back flushed for reuse. However, membrane filters offer a low cross-sectional filtration volume, quickly fill up with filtrate and have to be frequently flushed. Thus, there remains a need for a physical filter and method of filtration that utilizes high pore volume and surface area for reacting and/or collecting relatively high volumes of filtrate. The present novel technology addresses this need.

### SUMMARY

The present novel technology relates generally to the use of porous foamed glass bodies filters to purify liquids. One object of the present novel technology is to provide an improved method and apparatus for liquid filtration. Related objects and advantages of the present novel technology will be apparent from the following description.

### BRIEF DESCRIPTION OF THE DRAWINGS

FIG. 1 is a perspective drawing of a block of open pore foamed glass, a component of one embodiment of the present novel technology.

FIG. 2 is a partial cutaway view of a liquid filtration apparatus with open cell foamed glass media filters positioned in a liquid tank according to the embodiment of FIG. 1.

FIG. 3 is a partial cutaway view of the block of FIG. 1 and having a reactive film coating the interior interconnected pore network.

FIG. 4 is a schematic view of a method of disposing waste material captured in an open cell foamed glass member via fusion.

### DETAILED DESCRIPTION OF THE PREFERRED EMBODIMENT

For the purposes of promoting an understanding of the principles of the novel technology, reference will now be made to the embodiments illustrated in the drawings and specific language will be used to describe the same. It will nevertheless be understood that no limitation of the scope of the novel technology is thereby intended, such alterations and further modifications in the illustrated device, and such further applications of the principles of the novel technology as illustrated therein being contemplated as would normally occur to one skilled in the art to which the novel technology relates.

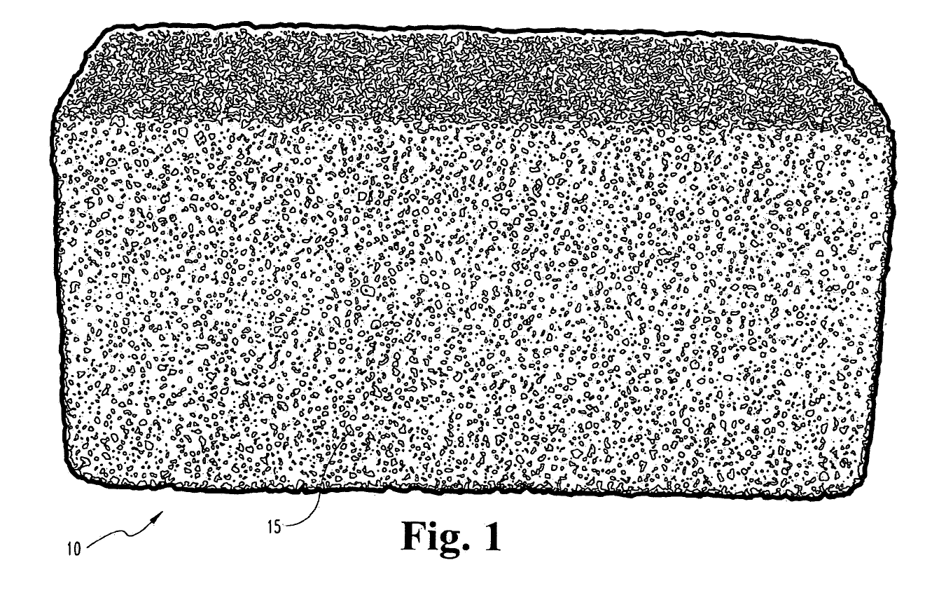

The present novel technology relates to a method of using a porous, open cell foamed glass substrate or filter 10 (see FIG. 1) for filtering impurities from water as well as for converting certain impurities into more useful materials. Foamed glass media or members have been adapted for agricultural use—predominately in areas where moisture retention and aeration are important factors in plant growth and health. These foamed glass media are generated with substantial open porosity to enhance water uptake and water availability for root systems, and are likewise applicable for liquid filtration. The filtration applications are for both particulate and monolithic foams 10 and in coated/non-coated systems.

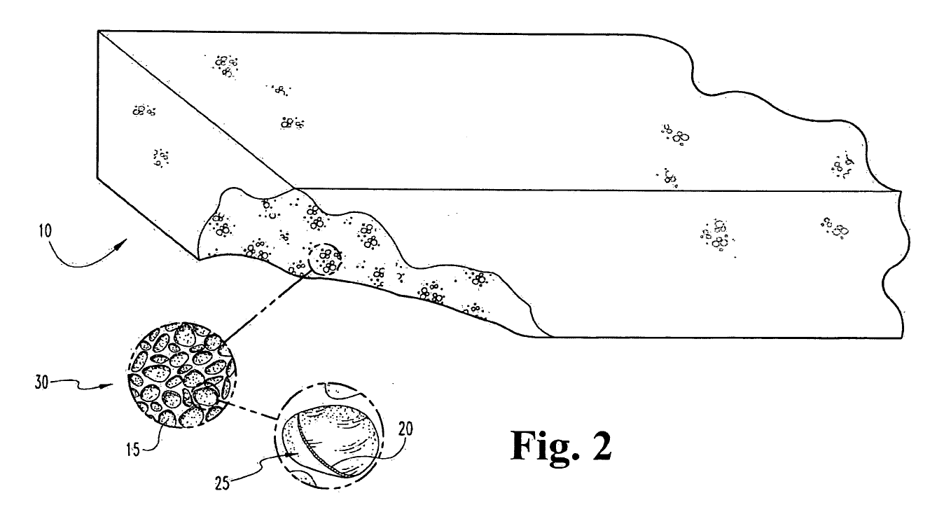

Typically, as illustrated in FIG. 2 in detail, foamed glass filtration media 10 are prepared with networks of interconnected pores 15 ranging from approximately 0.05 to about 0.25 inches diameter. More typically, the pores 15 are highly interconnected to define a pore network 30. These foamed glass media 10 have sufficient porosity to uptake over 150% their own mass in water weight. The water may be retained, be released by gravity or under applied pressure as a function of foam design. The foamed glass filtration media 10 are suitable for use in neutral pH solutions and with most acids.

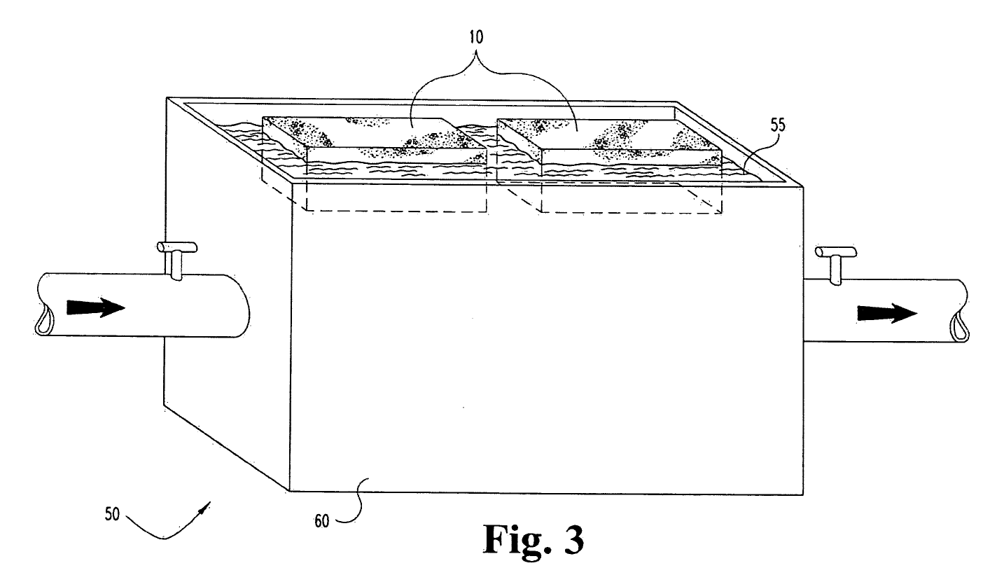

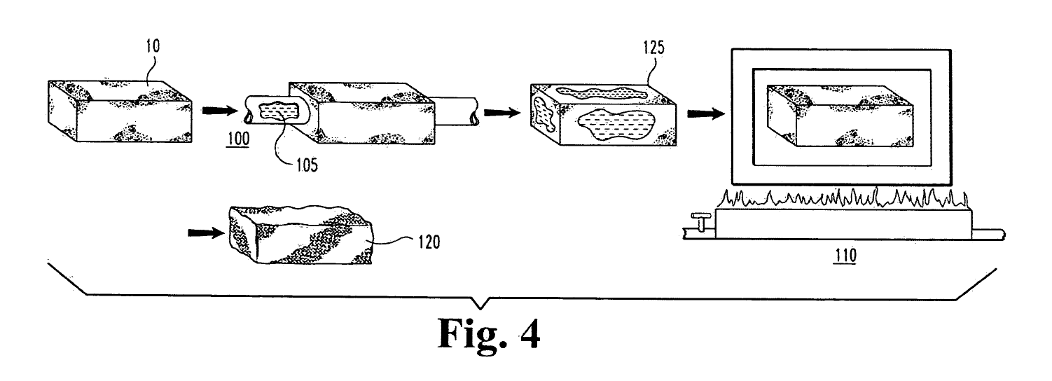

The foamed glass filter media 10 may be monolithic foam systems, where single or multiple foamed glass members 10 are used to filter water or other liquids at up to 80 psi pressure, or the foamed glass filter media 10 may be in the configuration of packed bed filters with pressure tolerance of at least about 160 PSI (see FIG. 3). Such foamed glass filtration media 10 may include a reaction layer 20, such as a biofilm, formed on the inner pore surfaces 25 for converting filtrate into useful material (such as a biofilm 20 for the conversion of ammonia into nitrates for use as fertilizer). Alternately, the open cell pore network 30 of the foamed glass body 10 may be used for the uptake of nitric acid solutions, such as those comprising common nuclear waste streams, wherein particulate nuclear waste is trapped in the pore network, allowing for the glass and waste component to be vitrified or fused into a single phase melt, facilitating ultimate disposal (see FIG. 4). Further, the soda lime silica glass system is compatible with ion-exchange resins and can thereby also act as a combination filter/substrate 10 for water purification. Additionally, non-porous, low density glass beads may also be used in conjunction with ion-exchange media, albeit with a significantly lower absorption coefficient.

### Biofilter Operation

FIG. 3 illustrates a filtration system 50 including foamed glass filtration media 10 positioned in liquid communication with a liquid to be purified 55 in a containment vessel 60. In operation, a biofilm 20 is provided on the interior surface 25 of the pore network 30 of blocks or other bodies 10 of the foamed glass material. The biofilm 20 is typically a bacterial colony or the like and is grown to substantially coat at least a portion of the surface area 25 defined by the pore network 30. The biofilm 20 is typically selected for its bioreactive properties, such as the conversion of an undesirable component of the liquid to be filtered into a more desirable material. For instance, some liquid waste streams are high in ammonia. Although ammonia may be desirable in some fertilizer uses, some plants, such as greenhouse tomatoes, prefer nitrates (NO3−)to ammonium (NH4+). Thus, it is desirable to convert ammonium to nitrates and, accordingly, a nitrobacter biofilm 20 is desirable. Such a reaction may be described as follows:

NH₄⁺+O₂→NO₂⁻+H⁺+H₂O (1)

NO₂⁻+O₂→NO₃⁻ (2)

As described above, ammonium is oxidized through the involvement of nitrosomonas (1) and nitrobacters (2) to nitrate filer media 10 with nitrite (NO2−) as an intermediate product. The open cell pore network 30 of the foamed glass is an improvement over polystyrene beads, as the foamed glass provides a stronger, more rigid biofilm support medium, and is less prone to picking up static charges. Further, the foamed glass pore network 30 does not substantially change size in response to temperature or to externally applied compressive forces.

### Nuclear Waste Disposal

Many nuclear wastes are in the form of nitric acid solutions. Most actinide and fission products are stable solutes in the nitric system, and the solutions are not corrosive to stainless steel. Vitrification, a common process for disposition of nuclear wastes, is however, complicated when acids must be converted to silicate (usually borosilcate) glass. Silicates are insoluble in nitric acid, and are thus typically suspended by physical agitation or other means and carefully metered to the furnace to prevent melt inhomogeneity.

Soda-lime glass can be foamed in such a manner to readily sorb nitric acid solutions. The foam glass media 10, in the form of individual particles, can each readily absorb over twice its weight in acid solution and can be directly converted to glass with no physical mixing required. The porous foamed glass media 10 can also act as a carrier of acid solution, as the porous foamed glass media 10 will retain the overwhelming majority of sorbed liquid indefinitely. This allows great range of design for pre-treatment and melter/furnace delivery mechanisms. Further, such a waste disposal system would be attractive in applications where precise knowledge of material accountability is required.

Glasses have been prepared using this novel technology, and are consistent with the requirements for geologic disposal in the U.S. These compositions are borosilicate glasses—part of the highly researched and documented composition range used by the Defense Waste Processing Facility and West Valley Demonstration Project. The novel technology is also compatible with specialty waste disposition and also large-scale melter operations.

Open cell foamed glass bodies 10 are typically derived from glass precursors that are first pulverized and then softened and foamed to achieve about 90% or greater void space. The pores 15 in the resulting foam are typically on the order of about 0.5 to 2 millimeters in diameter, although the pore size may readily be adjusted. The foamed glass typically each have material density of about 0.2 kg/l prior to crushing and sizing. Crushed foam particles have a typical bulk density of about 0.15 kg/l or lower, depending on particle size.

The starting material is typically soda-lime-silica (i.e., window glass); for nuclear processing applications window glass is preferred due to its low concentration of transition metal and sulfur oxides. Foamed glass bodies 10 derived from window glass is pure white (color can be added as required) in color and can be closely sized between ⅛th and 1 inch particles. Monolithic pieces are also readily also be produced.

The porosity of the (>50% open pores) is typically controlled to effectively and rapidly sorb liquids of 10 centipoise or lower viscosity. Typically, a foamed glass body 10 will absorb over 200 percent its weight in water. Further, the foamed glass body typically will retain the liquid indefinitely, with the majority of water loss due strictly to evaporation. Soda-lime glass has excellent chemical stability against nitric acid and is not generally attacked by common acids other than hydrofluoric.

### Experimental Data:

Multiple glass products have been generated using the absorptive foam. All glasses were derived from nitric acid solutions (containing uranium surrogates and other species used to modify the glass processing characteristics) sorbed onto foam glass particles 10. Additionally nitric acid solutions have been prepared with gadolinium and neodymium as a surrogate for uranium. Absorption tests indicate the acid solutions are absorbed in the same manner and to the same degree as water.

In general, the goal was to produce a single phase, homogeneous glass suitable for long-term storage and disposal. As borosilicate glass is the first type of glass accepted for geologic storage in the U.S., the process was tailored to produce a glass of this type, although other glass compositions can likewise be produced. As illustrated schematically in FIG. 4, foamed glass bodies 10 were saturated 100 with an acid solution of nuclear waste material 105 and then fused 110 into generally homogeneous, nonporous vitreous masses 120 for disposal. The nitric acid surrogate waste solutions 115 were doped with boron and lithium (a common glass flux) to generate an end product glass 120 with at least 5 percent by weight boron oxide that would melt at or below 1150° C. (mimicking the process/process region used for U.S. high-level nuclear waste glass). All glasses were prepared in an electric furnace. The materials were added solely in the form of pre-saturated foam 125. No mixing was allowed during the thermal processing. The foam was heated at 5° C. per minute to 800° C. 110 and then additional foam was added as the heated foam re-melted and densified. The final mass was then heated to 1150° C., allowed to soak for 3 hours and then cast onto a cool steel plate to yield a fused, generally nonporous vitreous body 120.

The preliminary process region appears to be relatively broad, being on the order of:

| | Weight Percent |
|---|---|
| Soda-Lime Glass | 50 to 80 |
| Boron Oxide | 5 to 15 |
| Re₂O₃ | 0 to 10 |
| R₂O | 5 to 15 |

Wherein Re2O3 represent rare earth oxides. Actinides are nominally less soluble on a molar basis, but have a greater atomic mass. Uranium, especially, is quite soluble in glass. Additional species can be added to the glass composition region if increased durability or decreased viscosity is desired. This process may likewise be used to dispose of waste streams containing non-radioactive heavy metal cations.

While the novel technology has been illustrated and described in detail in the drawings and foregoing description, the same is to be considered as illustrative and not restrictive in character, it being understood that only the preferred embodiment has been shown and described and that all changes and modifications that come within the spirit of the novel technology are desired to be protected.

We claim:

1. A method of treating liquids, comprising:
a) directing a liquid to be purified into a porous foamed glass member, wherein the foamed glass member is characterized by an open-cell interconnected pore network;
b) collecting waste materials in the open-cell interconnected pore network; and
c) directing filtered liquid away from the foamed glass member.

2. The method of claim 1 and further comprising:
d) after b), fusing the filtration member to isolate the collected waste materials in a fused glass matrix.

3. The method of claim 1 and further comprising:
d) after b), flushing the filtration member to remove the collected waste materials.

4. The method of claim 1 wherein the foamed glass member is periodically flushed to remove collected waste materials and wherein flushed waste materials is periodically collected for later dispersal.

5. The method of claim 1 wherein the open-cell interconnected pore network further defines a reaction surface and further comprising a reactive film substantially disposed on the reaction surface, wherein the reactive film is operable to convert at least some waste material into a predetermined useful material.

6. The method of claim 5 wherein the liquid is an ammonia solution, wherein the reactive film is a biofilm capable of converting ammoniums into nitrates and wherein the predetermined useful material is a nitrate fertilizer.

7. The method of claim 1 wherein the liquid is an acid solution containing nuclear waste.

8. A method of disposing of waste material in a waste stream, comprising:
a) positioning a porous foamed glass member characterized by an open-cell interconnected pore network in contact with a volume of liquid to be purified; and
b) removing an amount of an undesired material from the volume of liquid.

9. The method of claim 8 wherein the undesired material is transformed into a different material.

10. The method of claim 9 wherein the undesired material is ammonium and the different material is nitrate.

11. The method of claim 8 and further comprising:
c) disposing a reactive material within the interconnected pore network.

12. The method of claim 11 wherein the reactive material is a biofilm.

13. The method of claim 12 wherein the biofilm is a bacterial colony capable of consuming ammonium and excreting nitrates.

14. The method of claim 8 and further comprising:
c) heating the porous foamed glass member sufficiently to fuse the porous glass member and any contents into a substantially nonporous glass body.

15. The method of claim 14 wherein the undesired material is an acid solution of nuclear waster products and wherein the substantially nonporous glass body includes nuclear waste products dissolved in a vitreous material.

16. The method of claim 14 wherein the undesired material contains heavy metal cations.

17. A method of filtering a liquid, comprising:
a) positioning an open-cell interconnected glass pore network in liquid communication with a volume of liquid to be purified;
b) infiltrating an amount of waste material into the pore network; and
c) disposing of the waste material.

18. The method of claim 17 wherein the waste material is disposed of through conversion into a useful material.

19. The method of claim 17 wherein the waste material is disposed of through fusion of the pore network and waste material into a vitreous body.

20. The method of claim 17 wherein the waste material is a particulate filtrate and wherein the waste material is disposed of through physical removal from the liquid.
